(19) United States
(12) Patent Application Publication
(10) Pub. No.: US 2021/0229388 A1
(43) Pub. Date: Jul. 29, 2021

(54) Recycling Baler

(71) Applicant: WASTE REVELATION LLC, Valparaiso, IN (US)

(72) Inventor: Cole Doolittle, Valparaiso, IN (US)

(73) Assignee: WASTE REVELATION LLC, Valparaiso, IN (US)

(21) Appl. No.: 17/161,606

(22) Filed: Jan. 28, 2021

Related U.S. Application Data
(60) Provisional application No. 62/967,017, filed on Jan. 28, 2020.

(51) Int. Cl. B30B 9/30

(52) U.S. Cl. CPC B30B 9/3021; B30B 9/3057

(57) ABSTRACT

A compaction head for use with a hydraulic ram of a compaction baler includes an first plate operably coupled to the hydraulic ram, a second plate operably coupled to the first plate. The first and second plates are movable between a first position, where the first and second plates are spaced from each other by a distance, and a second position, where the first and second plates are in contact. The compaction head also includes a plurality of springs, a plurality of spikes extending from the first plate, and a plurality of apertures on the second plate. The plurality of springs is disposed between the first and second plates. In the first position, the plurality of spikes is at least partially withdrawn from the plurality of apertures, and in a second position, the plurality of spikes extends through the plurality of apertures.

### FIELD OF THE DISCLOSURE

The present disclosure generally relates to a recycling baler and, more particularly, to a recycling baler having a compaction head arranged to compress and puncture recyclable and/or non-recyclable material.

### BACKGROUND

Compaction balers receive recyclable and/or non-recyclable material, which is then compressed using a compaction head that is coupled to a hydraulic ram. The material is loaded into a loading area of the baler, and compressed by the hydraulic ram in a compaction chamber, from where compacted material may be secured in a bale and subsequently removed from the baler. In operation, material is deposited into the device via a loading area, a safety door or gate is closed and secured to ensure the safety of those operating the baler and, after securing the door or gate, movement of the hydraulic ram and the attached compaction head compresses the material disposed within the compaction chamber. After one or more compaction cycles, the material is bound, removed from the machine, and sent for recycling or disposal. Compaction balers may be, for example, downstroke balers wherein the hydraulic ram compresses the material by moving vertically, or horizontal stroke balers wherein the hydraulic ram compresses the material horizontally.

### SUMMARY

In accordance with a first aspect, a compaction baler for receiving and compressing a material comprises a housing defining an interior and a compaction chamber and adapted to receive the material, a hydraulic ram at least partially disposed within the interior and shiftable between a retracted position and an extended position, and a compaction head operably coupled to the hydraulic ram. The compaction head includes a first plate operably coupled to the hydraulic ram, and a second plate shiftably coupled to the first plate, wherein the first and second plates are shiftable relative to one another between a first position where the first and second plates are spaced apart by a first distance, and a second position where the first and second plates are spaced apart by a second distance less than the first distance, and further includes a plurality of springs disposed between the first plate and the second plate, the plurality of springs arranged to bias the first and second plates toward the first position. The first plate includes a plurality of spikes and the second plate including a plurality of apertures, with each of the plurality of spikes sized to extend through a corresponding one of the plurality of apertures toward a protruding position where the plurality of spikes protrude beyond the second plate when the first and second plates are in the second position. Thus, in response to shifting the hydraulic ram toward the extended position, the plurality spikes approach the protruding position in response to contact between the compaction head and the material.

In accordance with a second aspect, a compaction head for use with a hydraulic ram of a compaction baler, where the hydraulic ram is shiftable between a retracted position and an extended position, includes a first plate arranged for attachment to the hydraulic arm, and a second plate is shiftably coupled to the first plate. The first and second plates are shiftable relative to one another between a first position where the first and second plates are spaced apart by a first distance, and a second position where the first and second plates are spaced apart by a second distance less than the first distance. A plurality of springs are disposed between the first plate and the second plate. The plurality of springs are arranged to bias the first and second plates toward the first position. The first plate includes a plurality of spikes and the second plate includes a plurality of apertures. Each of the plurality of spikes are sized to extend through a corresponding one of the plurality of apertures toward a protruding position where the plurality of spikes protrude beyond the second plate when the first and second plates are in the second position. In the second aspect, in response to shifting the hydraulic ram toward the extended position, the plurality of spikes approach the protruding position in response to contact between the compaction head and the material.

In accordance with a third aspect, a method for operably coupling a compaction head to a compaction baler having a hydraulic ram includes providing the compaction baler having a housing defining an interior and a compaction chamber adapted to receive material, and the hydraulic ram. The method also includes providing the compaction head having a first plate operably coupled to the hydraulic ram, a second plate operably coupled to the first plate, the first and second plates configurable between a first position, where the first and second plates are spaced from each other by a distance, and a second position, where the first and second plates are in contact, a plurality of springs disposed between the first plate and the second plate, the plurality of springs configured to move the first and second plates from the second position to the first position, a plurality of spikes extending transversely from a surface of the first plate, and a plurality of apertures extending through the second plate, each aperture in the plurality of apertures sized to receive each spike in the plurality of spikes; in the first position, each spike in the plurality of spikes is at least partially withdrawn from each aperture in the plurality of apertures, and in the second position, each spike in the plurality of spikes extends through each aperture in the plurality of apertures. The method also includes coupling the hydraulic ram to the first plate of the compaction head.

In further accordance with any one or more of the foregoing first, second, or third aspects, a compaction baler and/or a compaction head for a baler may further include any one or more of the following preferred forms.

In some preferred forms, a tray is disposed within and/or beneath the housing and is positioned to capture and/or retain liquid.

In some preferred forms, a guard at least partially compasses the compaction chamber and is configured to contain liquid disposed within the material within the housing.

In some preferred forms, each of the plurality of springs is retained by a corresponding recess in at least one of the first plate or the second plate.

In some preferred forms, the second plate includes a first wall extending transversely from a first end of the second plate and has a first plate coupled thereto. The second plate also includes a second wall extending transversely from a second end of the second plate and has a second plate coupled thereto. The first and second plates extend at least partially over the first plate.

In some preferred forms, the plurality of spikes includes a first subset of spikes disposed proximate a second subset of spikes and a third subset of spikes disposed proximate a fourth subset of spikes. The first and second subsets of spikes are disposed toward a first end of the first plate, and the third and fourth subsets of spikes are disposed toward a second end of the first plate.

In some preferred forms, the plurality of spikes includes a fifth subset of spikes disposed between the second subset of spikes and the third subset of spikes.

In some preferred forms, a central axis of each spike in the first subset of spikes and a central axis of each spike in the second subset of spikes are disposed along a lateral axis. A central axis of each spike in the third subset of spikes and a central axis of each spike in the fourth subset of spikes are disposed along the lateral axis.

In some preferred forms, a central axis of each spike in the fifth subset of spikes is disposed along the lateral axis.

In some preferred forms, the first subset of spikes is spaced from the second subset of spikes by a first distance. The second subset of spikes is spaced away from the fifth subset of spikes by a second distance. The fifth subset of spikes is spaced from the third subset of spikes by a third distance. The third subset of spikes is spaced away from the fourth subset of spikes by a fourth distance. The first distance is substantially equal to the fourth distance. The second distance is substantially equal to the third distance.

In some preferred forms, the plurality of apertures includes a first subset of apertures disposed proximate a second subset of apertures. A third subset of apertures is disposed proximate a fourth subset of apertures. The first and second subsets of apertures are disposed towards a first end of the second plate. The third and fourth subsets of apertures are disposed towards a second end of the second plate.

In some preferred forms, the plurality of apertures includes a fifth subset of apertures disposed between the second subset of apertures and the third subset of apertures.

In some preferred forms, a central axis of each aperture in the first subset of apertures and a central axis of each aperture in the second subset of apertures are disposed along a lateral axis. Further, a central axis of each aperture in the third subset of apertures and a central axis of each aperture in the fourth subset of apertures are disposed along the lateral axis.

In some preferred forms, a central axis of each aperture in the fifth subset of apertures is disposed along the lateral axis.

In some preferred forms, the first subset of apertures is spaced from the second subset of apertures by a first distance. The second subset of apertures is spaced from the fifth subset of apertures by a second distance. The fifth subset of apertures is spaced from the third subset of apertures by a third distance. The third subset of apertures is spaced from the fourth subset of apertures by a fourth distance. The first distance and the fourth distance are substantially equal. The third distance and the fourth distance are substantially equal.

In some preferred forms, a first plurality of springs is disposed toward a first end of the first plate. A second plurality of springs is disposed toward a second end of the first plate.

### BRIEF DESCRIPTION OF THE DRAWINGS

The above needs are at least partially met through provision of the recycling baler described in the following detailed description, particularly when studied in conjunction with the drawings, wherein:

FIG. 1 illustrates a schematic view of an example recycling baler having a compaction head operably coupled to a hydraulic ram, constructed in accordance with the teachings of the present disclosure;

FIG. 2 illustrates the compaction head of FIG. 1, constructed in accordance with the teachings of the present disclosure;

FIG. 3 illustrates a front view of the compaction head of FIG. 1 in a first position, constructed in accordance with the teachings of the present disclosure; and

FIG. 4 illustrates a front view of the compaction head of FIG. 1 in a second position, constructed in accordance with the teachings of the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a compaction baler for receiving and compressing recyclable and/or non-recyclable material (hereinafter “the material”) includes a housing, a hydraulic ram at least partially disposed within the housing, and a compaction head operably coupled to the hydraulic ram. In operation, the material is loaded into the housing and a door of the compaction baler is closed and secured. A hydraulic system operably coupled to the hydraulic ram is engaged and the hydraulic ram begins to advance the compaction head toward the material within the housing. As the compaction head, with the aid of the hydraulic ram, compresses the material, a second plate of the compaction head translates toward a first head of the compaction head. In turn, a plurality of spikes extending from the first plate extend through a plurality of apertures disposed in the second plate as the compaction head compresses the material. So configured, the plurality of spikes penetrates the material as the compaction head compresses the material thereby releasing any liquids or gases stored within various containers in the material.

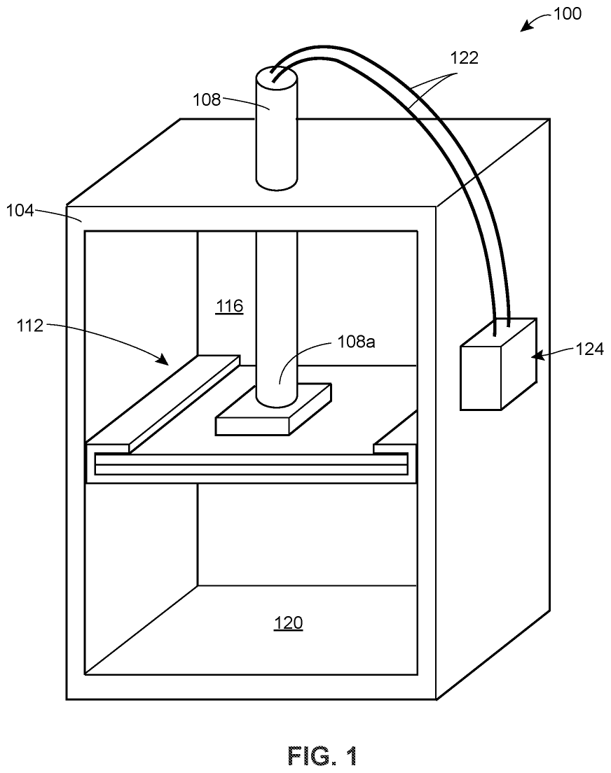

An example compaction baler 100 is illustrated in FIG. 1 and includes a housing 104, a hydraulic ram 108, and a compaction head 112. The housing 104 defines an interior 116 and a compaction chamber 120 disposed within the interior 116 and adapted to receive the material. As illustrated in FIG. 1, the compaction chamber 120 is disposed below the compaction head 112 thereby allowing the compaction head 112 to compress the material. While not illustrated herein, the compaction baler 100 may also include a door or gate to assist in retaining the material within the compaction chamber 120. The compaction baler 100 also includes a hydraulic system 124 operatively coupled to the hydraulic ram 108 via a plurality of hoses 122. While not illustrated herein, the hydraulic system 124 may also include a hydraulic fluid reservoir, a primary energy source, a hydraulic pump, a pressure relief valve, a pressure indicator, a direction control valve, an actuator, and any other components necessary to operate the hydraulic ram 108. As illustrated in FIG. 1, the compaction head 112 is operably coupled to the hydraulic ram 108. In particular, a first end 108a of the hydraulic ram 108 is operably coupled to the compaction head 112. For example, the compaction head 112 can be coupled to the hydraulic ram 108 via a fastener, snap-fit, weld, or any other coupling means capable of securing the compaction head 112 to the hydraulic ram 108. While FIG. 1 illustrates a vertical compaction baler, it is envisioned that the claimed compaction head 112 can be used in a horizontal compaction baler in other embodiments.

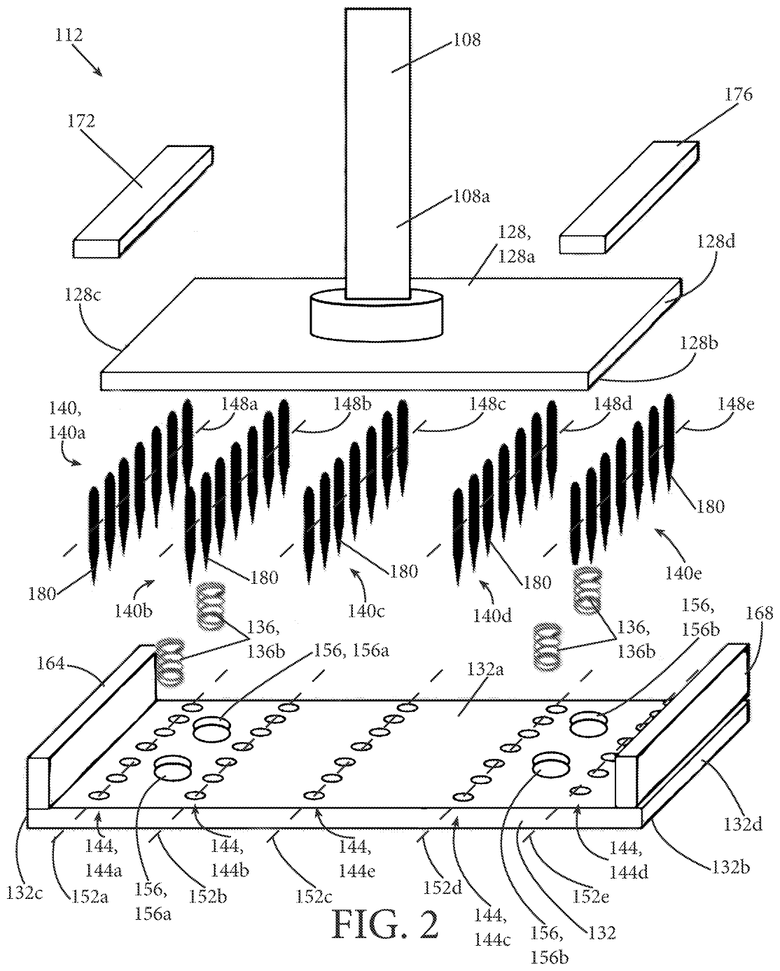

Turning to FIG. 2, which illustrates the example compaction head 112 of FIG. 1 that includes a first plate 128, a second plate 132, a plurality of springs 136, a plurality of spikes 140, and a plurality of apertures 144. In the example shown, each of the pluralities of springs 136 is a coil spring. However, one of skill in the relevant art, upon a reading of the present disclosure, will understand that the springs 136 may be a compressed gas cylinder, a hydraulic spring, a pneumatic spring, a magnetic spring, a resilient element, or any other suitable biasing component. The first plate 128 may be operably coupled to the hydraulic ram 108 and the second plate 132 may be operably coupled to the first plate 128. In the compaction head 112 of FIG. 2, the first plate 128 has a rectangular shape that includes a first surface 128a and a second surface 128b. Additionally, the first surface 128a of the first plate 128 is operably coupled to the hydraulic ram 108 and the second surface 128b of the first plate 128 includes the plurality of spikes 140 extending transversely therefrom. The plurality of spikes 140 illustrated in FIG. 2 includes a first subset of spikes 140a, a second subset of spikes 140b, a third subset of spikes 140c, a fourth subset of spikes 140d, and a fifth subset of spikes 140e. While the first, second, third, fourth, and fifth subsets of spikes 140a-d are illustrated in FIG. 2, it is envisioned that fewer or more subsets of spikes 140 can be attached to the second surface 128b of the first plate 128.

In any event, the first subset of spikes 140a illustrated in FIG. 2 is disposed proximate a second subset of spikes 140b, and the third subset of spikes 140d is disposed proximate the fourth subset of spikes 140e. In particular, the first subset of spikes 140a is disposed toward a first end 128c of the first plate 128 such that the first and second subset sets of spikes 140a, 140b are disposed by a distance D1. Similarly, the fourth subset of spikes 140e is disposed toward a second end 128d of the first plate 128 such that the third and fourth subsets of spikes 140d, 140e are separated by a distance D2. Disposed between the second subset of spikes 140b and the third subset of spikes 140d is the fifth subset of spikes 140c. In particular, the fifth subset of spikes 140c is disposed a distance D3 from the second subset of spikes 140b and a distance D4 from the third subset of spikes 140d. As illustrated in FIG. 2, the distance D1 and the distance D2 are substantially similar in length and the distance D3 and the distance D4 are substantially similar in length.

Further, the plurality of spikes 140 may be arranged in a pattern P in any suitable orientation on the first plate 128. For example, the first subset of spikes 140a, as illustrated in FIG. 2, can be arranged in a column such that each spike in the first subset of spikes 140a is arranged along a transverse axis 148a. Similarly, each spike in the second, third, fourth, and fifth subsets of spikes 140b-e may be disposed along separate transverse axes 148b-e that are all disposed a distance away from each other. In other words, each central axis of each spike in the first, second, third, fourth, and fifth subsets of spikes 140a-e may be arranged along separate transverse axes 148a-e that are all disposed a distance away from each other. However, in other examples, the first, second, third, fourth, and fifth subsets of spikes 140a-e can be arranged in various other patterns.

Similarly, the second plate 132 has a rectangular shape having a first surface 132a and a second surface 132b. As illustrated in FIG. 2, the second plate 132 includes a plurality of apertures 144 extending from the first surface 132a to the second surface 132b of the second plate 132. The plurality of apertures 144 illustrated in FIG. 2 includes a first subset of apertures 144a disposed proximate a second subset of apertures 144b, and a third subset of apertures 144c is disposed proximate a fourth subset of apertures 144d. In particular, the first subset of apertures 144a is disposed toward a first end 140c of the second plate 132 such that the first and second subsets of apertures 144a, 144b are separated by a distance D5. Similarly, the fourth subset of apertures 144e is disposed toward a second end 132d of the second plate 132 such that the third and fourth subsets of apertures 144c, 144d are separated by a distance D6. Disposed between the second subset of apertures 144b and the third subset of apertures 144c is a fifth subset of apertures 144e. In particular, the fifth subset of apertures 144e is disposed a distance D7 from the second subset of apertures 144b and a distance D8 from the third subset of apertures 144c. As illustrated in FIG. 2, the distance D5 and the distance D6 are substantially similar in length and the distance D7 and the distance D8 are substantially similar in length.

Further, the plurality of apertures 144 may be arranged in any orientation on the second plate 132. For example, the first subset of apertures 144a, as illustrated in FIG. 2, can be arranged in a column such that each aperture in the first subset of apertures 144a is arranged along a transverse axis 152a. Similarly, each aperture in the second, third, fourth, and fifth subsets of apertures 144b-e may be disposed along separate transverses axes 152b-e that are all disposed a distance away from each other. In other words, each central axis of each aperture in the first, second, third, fourth, and fifth subsets of apertures 144a-e may be arranged along separate transverse axes 152a-e that are all disposed a distance away from each other. However, in other examples, the first, second, third, fourth, and fifth subsets of apertures 144a-e can be arranged in various other patterns.

FIG. 2 additionally illustrates a plurality of springs 136 that are disposed between the first and second plates 128, 132. Although, other components, including, but not limited to compression springs, extension springs, torsion springs, constant force spring, Belleville springs, drawbar springs, volute springs, garter springs, as well as any other biasing element, may prove suitable. The plurality of springs 136 provides a biasing force that separates the first and second plates 128, 132 such that when the second plate 132 is not in contact with the material within the compaction baler 100, each spike in the plurality of spikes 140 is at least partially withdrawn from each aperture in the plurality of apertures 144. So configured, the biasing force provided by the plurality of springs 136 prevents a user of the compaction baler 100 from being injured by the plurality of spikes 140. In particular, the second plate 132 includes a plurality of recesses 156 that are adapted to receive each spring in the plurality of springs 136. The plurality of recesses 156 may be disposed anywhere along the second plate 132 to adequately provide a biasing force to separate the first and second plates 128, 132. For example, as illustrated in FIG. 2, a first plurality of recesses 156a is disposed between the first and second subsets of apertures 140a, 140b and a second plurality of recesses 156b is disposed between the third and fourth subsets of apertures 140d, 140e.

Further, the second plate 132 includes retaining features 160 such that the first plate 128 remains coupled to the second plate 132 when the first and second plates 128, 132 are spaced away from each other by a distance. In some examples, the retaining features 160 include a first upwardly extending wall portion 164, a second upwardly extending wall 168, a first capture portion 172, and a second capture portion 176. In particular, the first wall portion 164 extends transversely from the first end 132c of the second plate 132 and the second wall portion 168 extends transversely from the second end 132d of the second plate 132. The first capture portion 172 is coupled to the first wall portion 164 and extends at least partially over the first plate 128 and the second retention plate 176 is coupled to the second wall 168 and extends at least partially over the first plate 128. The first plate 128 is disposed adjacent the first and second capture portions 172, 176 when the first and second plates 128, 132 are in the first position. In other examples, the retaining features 160 can include a groove (not illustrated) disposed along an inner surface of the first and second walls 164, 168 and a tongue (not illustrated) extending from the first and second sides of the first plate 128 that are received by the groove disposed in the first and second walls 164, 168.

While the first plate 128 and/or the second plate 132 have been illustrated and discussed as having a rectangular shape, the first and second plates 128, 132, in other examples, can have a circular, triangular, or any other shape that is suitable for the compaction baler 100 that receives the compaction head 112.

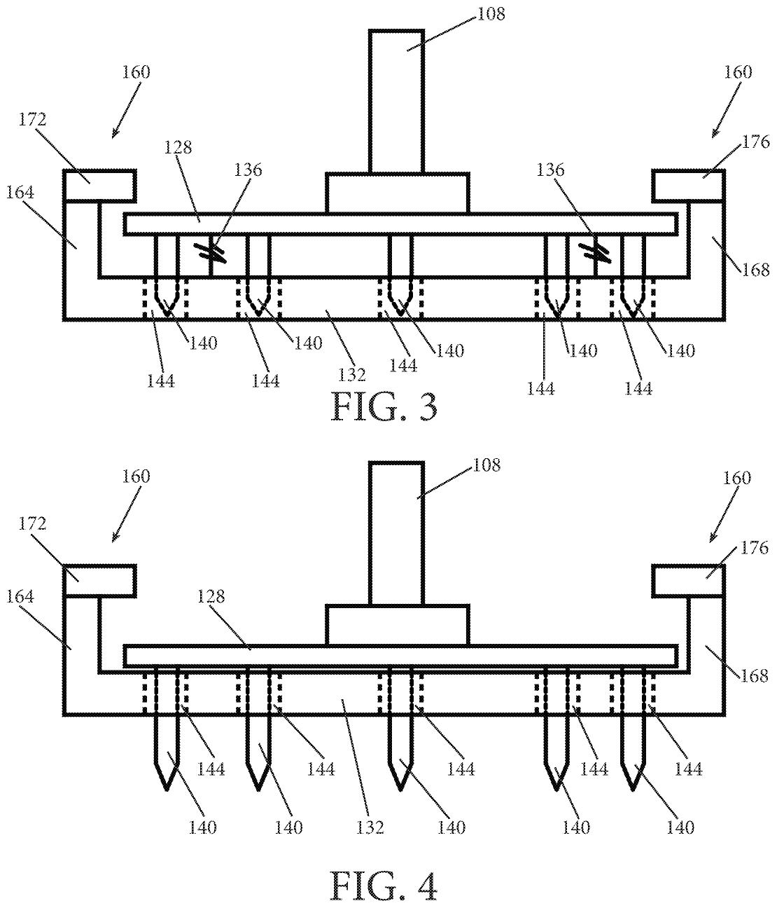

Turning now to FIGS. 3 and 4, the first and second plates 128, 132 are configurable between a first position (FIG. 3), when the compaction head 112 is not in contact with the material prior to or after compaction, and a second position (FIG. 4), when the compaction head 112 is in contact with the material during compaction. In the first position, the first and second plates 128, 132 are spaced away from each other by a distance D9. So configured, each spike in the plurality of spikes 140 is at least partially withdrawn from each aperture in the plurality of apertures 144 so that a tip portion 180 of each spike in the plurality of spikes 140 is disposed between in each aperture of the plurality of apertures 144. In the second position, the first and second plates 128, 132 are in contact. So configured, each spike in the plurality of spikes 140 is at least partially extends through each aperture in the plurality of apertures 144 so that the tip portion 180 of each spike in the plurality of spikes 140 is disposed through each aperture in the plurality of apertures 144.

In operation, prior to the compaction head 112 coming into contact with the material within the compaction baler 100, the compaction head 112 is disposed in the first position, as illustrated in FIG. 3. Once the compaction head 112 comes into contact with the material, the compaction head 112 may remain in the position illustrated in FIG. 3 until the downward force exerted by the hydraulic ram 108 and the force exerted against the second plate 132 by the material overcomes the spring force of the plurality of spring 136 disposed between the first and second plates 128, 132. Once the spring forces are overcome, the compaction head 112 transitions to the second position, as illustrated in FIG. 4, where the first and second plates 128, 132 come into contact. So configured, each spike in the plurality of spikes 140 at least partially extends through each aperture in the plurality of apertures 144 such that the tip portion 180 of each spike in the plurality of spikes 140 extends through the second surface 132b of the second plate 132.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A compaction baler for receiving and compressing a material, the baler comprising:
a housing defining an interior and a compaction chamber and adapted to receive the material;
a hydraulic ram at least partially disposed within the interior and shiftable between a retracted position and an extended position; and
a compaction head operably coupled to the hydraulic ram, the compaction head comprising:
a first plate operably coupled to the hydraulic ram, and a second plate shiftably coupled to the first plate, wherein the first and second plates are shiftable relative to one another between a first position where the first and second plates are spaced apart by a first distance, and a second position where the first and second plates are spaced apart by a second distance less than the first distance, and including a plurality of springs disposed between the first plate and the second plate, the plurality of springs arranged to bias the first and second plates toward the first position;
the first plate including a plurality of spikes and the second plate including a plurality of apertures, each of the plurality of spikes sized to extend through a corresponding one of the plurality of apertures toward a protruding position where the plurality of spikes protrude beyond the second plate when the first and second plates are in the second position;
wherein, in response to shifting the hydraulic ram toward the extended position, the plurality spikes approach the protruding position in response to contact between the compaction head and the material.

2. The compaction baler of claim 1, further comprising a tray positioned below the compaction chamber and arranged to capture liquid.

3. The compaction baler of claim 2, further comprising a guard at least partially encompassing the compaction chamber and configured to contain liquid disposed within the material within the housing.

4. The compaction baler of claim 1, wherein each of the plurality of springs is retained by a corresponding recess in at least one of the first plate or the second plate.

5. The compaction baler of claim 1, wherein the second plate includes an upwardly extending wall portion that extends above the first plate, and including a capture portion coupled to the wall portion that extends at least partially over the first plate, the first plate disposed adjacent the capture portion when the first and second plates are in the first position.

6. The compaction baler of claim 1, wherein the plurality of spikes and the plurality of apertures are arranged in a pattern.

7. A compaction head for use with a hydraulic ram of a compaction baler, the hydraulic ram shiftable between a retracted position and an extended position, the compaction head comprising:
a first plate arranged for attachment to the hydraulic ram, and a second plate shiftably coupled to the first plate, wherein the first and second plates are shiftable relative to one another between a first position where the first and second plates are spaced apart by a first distance, and a second position where the first and second plates are spaced apart by a second distance less than the first distance, and including a plurality of springs disposed between the first plate and the second plate, the plurality of springs arranged to bias the first and second plates toward the first position;
the first plate including a plurality of spikes and the second plate including a plurality of apertures, each of the plurality of spikes sized to extend through a corresponding one of the plurality of apertures toward a protruding position where the plurality of spikes protrude beyond the second plate when the first and second plates are in the second position;
wherein, in response to shifting the hydraulic ram toward the extended position, the plurality of spikes approach the protruding position in response to contact between the compaction head and the material.

8. The compaction head of claim 7, wherein each of the plurality of springs is retained by a corresponding recess in at least one of the first or the second plate.

9. The compaction head of claim 7, wherein the second plate includes an upwardly extending wall portion that extends above the first plate, and including a capture portion coupled to the wall portion that extends at least partially over the first plate, the first plate disposed adjacent the capture portion when the first and second plates are in the first position.

10. The compaction head of claim 7, wherein the plurality of spikes includes a first subset of spikes disposed proximate a second subset of spikes and a third subset of spikes disposed proximate a fourth subset of spikes, the first and second subsets of spikes disposed toward a first end of the first plate, and the third and fourth subsets of spikes disposed toward a second end of the first plate.

11. The compaction head of claim 10, wherein a central axis of each spike in the first subset of spikes and a central axis of each spike in the second subset of spikes are disposed along a lateral axis; and
wherein, a central axis of each spike in the third subset of spikes and a central axis of each spike in the fourth subset of spikes are disposed along the lateral axis.

12. The compaction head of claim 11, wherein the plurality of spikes includes a fifth subset of spikes disposed between the second subset of spikes and the third subset of spikes, and
wherein a central axis of each spike in the fifth subset of spikes is disposed along the lateral axis.

13. The compaction head of claim 12, wherein the first subset of spikes is spaced from the second subset of spikes by a first distance, the second subset of spikes is spaced away from the fifth subset of spikes by a second distance, the fifth subset of spikes is spaced from the third subset of spikes by a third distance, and the third subset of spikes is spaced from the fourth subset of spikes by a fourth distance; and
wherein, the first distance is substantially equal to the fourth distance, and the second distance is substantially equal to the third distance.

14. The compaction head of claim 7, wherein the plurality of apertures includes a first subset of apertures disposed proximate a second subset of apertures and a third subset of apertures disposed proximate a fourth subset of apertures, the first and second subsets of apertures disposed towards a first end of the second plate, and the third and fourth subsets of apertures disposed towards a second end of the second plate.

15. The compaction head of claim 14, wherein the plurality of apertures includes a fifth subset of apertures disposed between the second subset of apertures and the third subset of apertures.

16. The compaction head of claim 15, wherein a central axis of each aperture in the first subset of apertures and a central axis of each aperture in the second subset of apertures are disposed along a lateral axis; and
wherein, a central axis of each aperture in the third subset of apertures and a central axis of each aperture in the fourth subset of apertures are disposed along the lateral axis.

17. The compaction head of claim 16, wherein a central axis of each aperture in the fifth subset of apertures is disposed along the lateral axis.

18. The compaction head of claim 15, wherein the first subset of apertures is spaced from the second subset of apertures by a first distance, the second subset of apertures is spaced from the fifth subset of apertures by a second distance, the fifth subset of apertures is spaced from the third subset of apertures by a third distance, and the third subset of apertures is spaced from the fourth subset of apertures by a fourth distance; and
wherein, the first distance and the fourth distance are substantially equal, and the third distance and the fourth distance are substantially equal.

19. The compaction head of claim 7, wherein a first plurality of springs is disposed toward a first end of the first plate and a second plurality of springs is disposed toward a second end of the first plate.

20. A method for operably coupling a compaction head to a hydraulic ram of a compaction baler, the method comprising:
providing, the compaction baler having a housing defining an interior and a compaction chamber and adapted to receive material;
providing, the hydraulic ram being at least partially disposed within the interior and shiftable between a retracted position and an extended position;
providing, the compaction head having a first plate, a second plate shiftably coupled to the first plate, wherein the first and second plates are shiftable relative to one another between a first position where the first and second plates are spaced apart by a first distance, and a second position where the first and second plates are spaced apart by a second distance less than the first distance, a plurality of springs arranged to bias the first and second plates towards the first position, the first plate including a plurality of spikes and the second plate including a plurality of apertures, each of the plurality of spikes sized to extend through a corresponding one of the plurality of apertures toward a protruding position where the plurality of spikes protrude beyond the second plate when the first and second plates are in the second position, wherein, in response to shifting the hydraulic ram toward the extended position, the plurality of spikes approach the protruding position in response to contact between the compaction head and the material;
coupling the hydraulic ram to the first plate of the compaction head.
